(19) United States
(12) Patent Application Publication
(10) Pub. No.: US 2011/0175812 A1
(43) Pub. Date: Jul. 21, 2011

(54) Radio-frequency mouse

(75) Inventors: Chun-Nan Hsien, Xinbei City (TW); Ruei-Chen Mao, Xinbei City (TW); Chien-Lung Lu, Xinbei City (TW); Yao-Hung Chuang, Xinbei City (TW); Wen-Chang Chang, Xinbei City (TW)

(73) Assignee: KYE SYSTEMS CORP., Xinbei City (TW)

(21) Appl. No.: 12/929,297

(22) Filed: Jan. 13, 2011

(30) Foreign Application Priority Data
Jan. 20, 2010 (TW) 099101543

(51) Int. Cl. G06F 3/033

(52) U.S. Cl. 345/163

(57) ABSTRACT

A radio-frequency mouse is used for receiving an electromagnetic wave transmitted by an electronic device. The radio-frequency mouse includes a RF transceiver, a sensor, a micro-controller, a battery, and a power management circuit. The RF transceiver receives and converts an electromagnetic wave into a RF power. The sensor outputs an operation signal according to an operating condition of the RF mouse. The micro-controller transfers an operation signal to the RF transceiver, and the RF transceiver transmits the operation signal to the electronic device. The power management circuit receives the RF power, and selectively supplies the RF power or the battery power of the battery to the sensor and the micro-controller according to RF power. Thus, when the RF power is higher than a preset value, the RF mouse is supplied with power, thereby saving the battery power of the RF mouse and improving a battery life of the RF mouse.

### CROSS-REFERENCE TO RELATED APPLICATIONS

This non-provisional application claims priority under 35 U.S.C. §119(a) on Patent Application No(s). 099101543 filed in Taiwan, R.O.C. on Jan. 20, 2010, the entire contents of which are hereby incorporated by reference.

### BACKGROUND OF THE INVENTION

1. Field of Invention

The present invention relates to a mouse, and more particularly to a radio-frequency mouse used for receiving an electromagnetic wave transmitted by an electronic device.

2. Related Art

Currently, a wireless mouse commercially available in the market uses a battery as a power supply. An operating circuit and a wireless transceiver circuit of the wireless mouse may consumes a large quantity of current, so the user needs to replace the battery of the wireless mouse or recharge the battery frequently to ensure normal operation of the wireless mouse.

Therefore, a relevant technology of a power saving wireless mouse is gradually developed, which refers to ROC Publication No. 590290. In this patent, a power saving device for a wireless input equipment is disclosed. The device mainly includes a power source; a wireless input equipment, having an operating circuit and a wireless radio-frequency circuit; a sensor, transmitting a signal when an object enters a sensing range of the sensor; and a micro-processor, connected to the sensor, and used for receiving the signal transmitted by the sensor. The micro-processor selectively controls the operating circuit and the wireless radio-frequency circuit to enter a power-saving mode or an operating mode. When the object enters the sensing range of the sensor, the micro-processor controls the wireless radio-frequency circuit and the operating circuit to enter the operating mode. When the operating circuit does not transmit any signal for a preset time period, the micro-processor controls the wireless radio-frequency circuit and the operating circuit to enter the power-saving mode.

The power saving device uses the sensor to sense whether a palm of a user enters the sensing range or not. The palm does not enter the sensing range, indicating that no one is using the equipment, so the equipment enters the power-saving mode.

The above patent proposes a technology that a wireless radio-frequency mouse automatically enters a power-saving mode when not being used by the user. This technology may save battery power consumption. However, the technology cannot solve the problem that the battery power runs out after the battery of the radio-frequency mouse is used for a period of time. For the user, battery replacement is a huge trouble in using the radio-frequency mouse. Although the radio-frequency mouse may enter the power-saving mode automatically, the battery capacity (that is, a time period of continuous use) still cannot satisfy needs of the user. Sometimes, when no battery is taken along, the user must go out to purchase the batteries. It causes great inconvenience.

### SUMMARY OF THE INVENTION

In view of the above problems, the present invention is directed to a radio-frequency mouse. It can utilize a radio-frequency power converted from the electromagnetic wave. When the radio-frequency mouse is in an idle state (or referred to as, a power-saving state), the radio-frequency power supplies power to the radio-frequency mouse for use and to recharge the battery power. Accordingly, the number of battery replacements is reduced or even there is no need to replace battery at all.

According to an embodiment, the radio-frequency mouse is used for receiving an electromagnetic wave transmitted by an electronic device. The radio-frequency mouse comprises a radio-frequency transceiver module, a sensor, a micro-controller, a battery, and a power management circuit. The radio-frequency transceiver module receives and converts the electromagnetic wave into a radio-frequency power. The sensor outputs an operation signal according to an operating condition of the radio-frequency mouse. The micro-controller transfers the operation signal to the radio-frequency transceiver module, and the radio-frequency transceiver module transmits the transferred operation signal to the electronic device. The battery provides a battery power. The power management circuit receives the radio-frequency power, and selectively supplies the radio-frequency power or the battery power to the sensor and the micro-controller according to the radio-frequency power.

The micro-controller transmits an idle signal when the operation signal is an idle state. The power management circuit selectively supplies the radio-frequency power to the sensor and the micro-controller when the radio-frequency power is higher than a preset value and the idle signal is received, and selectively supplies the battery power to the sensor and the micro-controller when the radio-frequency power is lower than a preset value or the idle signal is not received.

The power management circuit comprises a comparison circuit, a logic element, and a power switch element. The comparison circuit compares the preset value and the radio-frequency power and outputs a comparison signal. The logic element outputs a logic signal when the comparison signal is at the high level and the idle signal is at the high level. The power switch element receives the radio-frequency power and the battery power, and controls to supply the radio-frequency power to the sensor and the micro-controller when the logic signal is at the high level.

The radio-frequency transceiver module comprises an antenna, a resonance circuit, a boost up circuit, and a rectifier circuit. The antenna receives and converts an electromagnetic wave into an alternating current. The resonance circuit receives the alternating current and outputs a resonance voltage. The boost up circuit boosts the resonance voltage and then outputs the boosted resonance voltage to the rectifier circuit. The rectifier circuit receives the boosted resonance voltage and converts the boosted resonance voltage into the radio-frequency power.

According to another embodiment, the power management circuit further comprises a charging circuit. The power management circuit selectively charges the battery with the radio-frequency power through the charging circuit according to the radio-frequency power.

According to the above embodiments, the electromagnetic wave transmitted by the radio-frequency transceiver can be effectively converted into the radio-frequency power. When the radio-frequency power is higher than a preset value, the radio-frequency power is selected to be supplied to the radio-frequency mouse, thereby saving the battery power of the battery of the radio-frequency mouse. Furthermore, when the radio-frequency power is higher than the preset value, the battery can be recharged with the radio-frequency power, thus further increasing the battery life.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an application of the present invention in an electronic device;

FIG. 2 is a schematic block diagram of a circuit of a radio-frequency transceiver according to the present invention;

FIG. 3 is a schematic block diagram of a circuit of a radio-frequency mouse according to the present invention; and

FIG. 4 is a schematic block diagram of a circuit of a power management circuit according to the present invention.

### DETAILED DESCRIPTION OF THE INVENTION

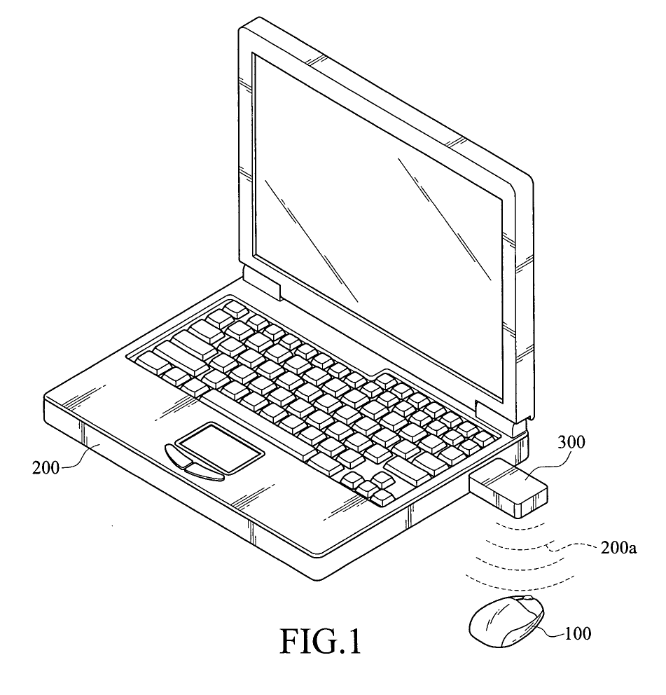

FIG. 1 is a schematic view of an application of the present invention in an electronic device. Referring to FIG. 1, the radio-frequency mouse 100 of the present invention is used for receiving an electromagnetic wave 200a transmitted by an electronic device 200. The electromagnetic wave 200a may be generated by a radio-frequency unit built in the electronic device 200 or by an external radio-frequency transceiver 300. In this embodiment, although the external radio-frequency transceiver 300 is taken as an example for illustration, the present invention is not limited thereto.

The electronic device 200 may be a notebook computer, a desktop computer or a setup box (STB). In this embodiment, the notebook computer is taken as an example for illustration, but the present invention is not limited thereto.

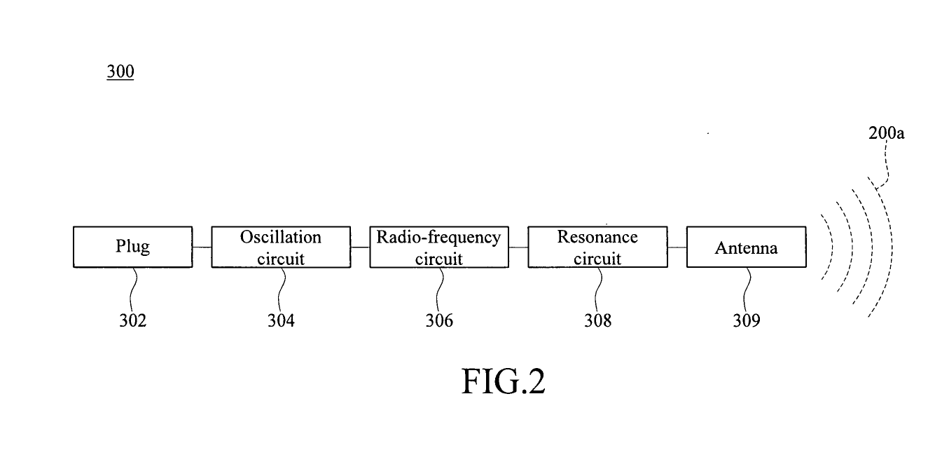

FIG. 2 is a schematic block diagram of a circuit of a radio-frequency transceiver 300 according to the present invention. Referring to FIG. 2, the radio-frequency transceiver 300 includes a plug 302, an oscillation circuit 304, a radio-frequency circuit 306, a resonance circuit 308, and an antenna 309.

The plug 302 may be electrically connected to the electronic device 200, so the electronic device 200 supplies power and forms a communication connection relation with the electronic device 200. The plug may be, but not limited to, a universal serial bus (USB).

The oscillation circuit 304 may be a quartz oscillator, which is used for generating a signal at a certain frequency to the radio-frequency circuit 306. The radio-frequency circuit 306 may be, but not limited to, a radio-frequency integrated circuit (RF IC), which is used for converting the frequency signal generated by the oscillation circuit 304 into pulsating direct currents in different phases. The resonance circuit 308 may be, but not limited to, a capacitor-inductor series resonance circuit 308. The resonance circuit 308 resonates with the pulsating direct currents in different phases to form an electromagnetic wave 200a, which is then transferred by the antenna 309.

The antenna 309 may be several groups of parallel antennas combined in a composite synchronous manner, so as to generate a mutual assisting force, thus enhancing the transmission power. Furthermore, the design of the antenna may be added, that is, an enhanced antenna may be adopted to enhance power in a certain direction, so as to obtain larger transmission energy.

The frequency of the electromagnetic wave 200a may be, but not limited to, 2.4×10⁹ Hz.

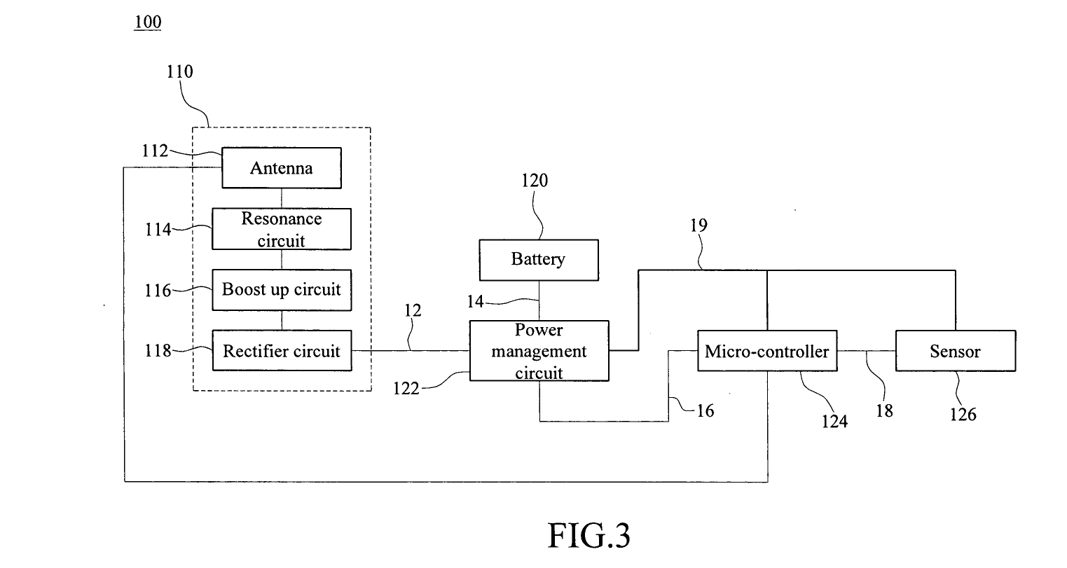

FIG. 3 is a schematic block diagram of a circuit of a radio-frequency mouse according to the present invention. Referring to FIG. 3, the radio-frequency mouse 100 may include a radio-frequency transceiver module 110, a battery 120, a power management circuit 122, a sensor 126, and a micro-controller 124.

The radio-frequency transceiver module 110 receives an electromagnetic wave 200a transmitted by the radio-frequency transceiver 300, and the electromagnetic wave 200a converts the electromagnetic wave 200a into a radio-frequency power 12. The detailed illustration of the conversion of the electromagnetic wave 200a into the radio-frequency power 12 by the radio-frequency transceiver module 110 is given below.

The sensor 126 outputs an operation signal 18 to the micro-controller 124 according to an operating condition of the radio-frequency mouse 100. The sensor 126 may be an input sensor element on the radio-frequency mouse 100 and may also be a sensor element additionally disposed on the radio-frequency mouse 100. The input sensor element on the radio-frequency mouse 100 may be, but not limited to, a left button, a right button, a wheel or a displacement sensor element.

For example, the sensor 126 is a displacement sensor element, and when the user uses the radio-frequency mouse 100, the sensor 126 transfers the operation signal 18 to the micro-controller 124. The micro-controller 124 receives the above operation signal 18 and then determines the operation signal 18 is in an idle state or a busy state. The busy state refers to the state that the sensor 126 outputs displacement information to the micro-controller 124 when the user moves the radio-frequency mouse 100. The displacement information may be, but not limited to, a moving direction and an amount of movement (a relative moving distance). The idle state refers to a state that the user does not move the radio-frequency mouse 100 for a preset time period (for example, but not limited to, 0.7 second or 1 second). The idle state may also be referred to as the power-saving mode.

When the user moves the radio-frequency mouse 100, the displacement sensor element transmits an operation signal 18 to the micro-controller 124, the micro-controller 124 receives and processes the operation signal 18, and then transmits the processed operation signal 18 through the antenna 112 of the radio-frequency transceiver module 110.

The signal transmitted by the antenna 112 is received by the radio-frequency transceiver 300, and the radio-frequency transceiver 300 decodes the received signal and then transfers the decoded signal to the electronic device 200, so as to perform manipulate indexes of the electronic device 200.

The relative actions of the radio-frequency mouse in the idle state will be illustrated subsequently together with other elements.

The battery 120 provides a battery power 14 to the power management circuit 122. The power management circuit 122 receives the radio-frequency power 12 and the battery power 14, and selectively supplies the radio-frequency power 12 or the battery power 14 to the sensor 126 and the micro-controller 124 according to the radio-frequency power 12. Here, the power is supplied to two elements, namely, the sensor 126 and micro-controller 124, but in practice, the power may be supplied to other power consuming elements in addition to the battery.

The magnitude of the radio-frequency power 12 converted by the radio-frequency transceiver module 110 is related to the strength of the electromagnetic wave 200a transmitted by the radio-frequency transceiver 300, and may also be related to the distance of the radio-frequency mouse 100 away from the radio-frequency transceiver 300. When the distance of the radio-frequency mouse 100 away from the radio-frequency transceiver 300 is smaller, the radio-frequency power 12 converted by the radio-frequency transceiver module 110 is larger. On the contrary, the radio-frequency power 12 converted by the radio-frequency transceiver module 110 is smaller. Therefore, when the power management circuit 122 judges that the radio-frequency power 12 is higher than a preset value, which indicates that the current radio-frequency power 12 is sufficient for use by the radio-frequency mouse 100, so the power management circuit 122 cuts off the power supply to the battery 120, and supplies the radio-frequency power 12 to the sensor 126 and the micro-controller 124. If the power management circuit 122 determines that the radio-frequency power 12 is lower than a preset value, which indicates that the radio-frequency power 12 is insufficient for use by the radio-frequency mouse 100, so the power management circuit 122 controls to supply the battery power 14 to the sensor 126 and micro-controller 124.

The preset value is determined according to the lowest power required for operation of the sensor 126 and micro-controller 124. In general, the preset value may be a voltage value, for example, but not limited to, the lowest operating voltage of the sensor 126 and the micro-controller 124, that is, 2.7 volts or 3.0 volts. In order to maintain the level of the preset value, the preset value may be a preset level directly obtained from the battery 120 passing the voltage division circuit.

Therefore, the power management circuit 122 may selectively supply the battery power 14 or the radio-frequency power 12 to the radio-frequency mouse 100 at a proper time according to the power state of the radio-frequency power 12. This manner can effectively increase the life of the battery 120 and effectively make use of the radio-frequency power 12.

The radio-frequency transceiver module 110 includes an antenna 112, a resonance circuit 114, a boost up circuit 116, and a rectifier circuit 118. The antenna 112 receives the electromagnetic wave from the radio-frequency transceiver 300, and converts the electromagnetic wave 200a into an alternating current. The antenna 112 may be an antenna that is able to adjust a resonant power according to the frequency of the electromagnetic wave 200a transmitted by the radio-frequency transceiver 300.

The resonance circuit may be, but not limited to, an inductor-capacitor parallel resonance circuit, which is used for receiving the alternating current and outputting the resonance voltage. Then, the boost up circuit may be, but not limited to, a voltage doubling circuit, which is used for increasing the resonance voltage to a voltage level required by the radio-frequency mouse 100. Next, the rectifier circuit 118 may be, but not limited to, a bridge-type rectifier circuit, which is used for converting the booster signal of the boost up circuit outputs into the radio-frequency power 12. The radio-frequency power 12 may be a direct current.

According to another embodiment of the present invention, if the radio-frequency power 12 may supply enough power to the radio-frequency mouse 100 in the idle state, but is insufficient to supply power to the radio-frequency mouse 100 in the busy state, the power management circuit 122 is also required to determine whether the radio-frequency mouse 100 is in the idle state or not in addition to determination of the radio-frequency power 12.

The micro-controller 124 receives the operation signal 18 from the sensor 126, and then determines whether the radio-frequency mouse 100 is in the idle state. If yes, the micro-controller 124 transmits an idle signal 16 to the power management circuit 122. The power management circuit 122 supplies the radio-frequency power 12 to the sensor 126 and the micro-controller 124 when the radio-frequency power 12 is higher than a preset value and the idle signal 16 is received. The power management circuit 122 supplies the battery power 14 to power to the sensor 126 and the micro-controller 124 when the radio-frequency power 12 is lower than the preset value or the idle signal 16 is not received.

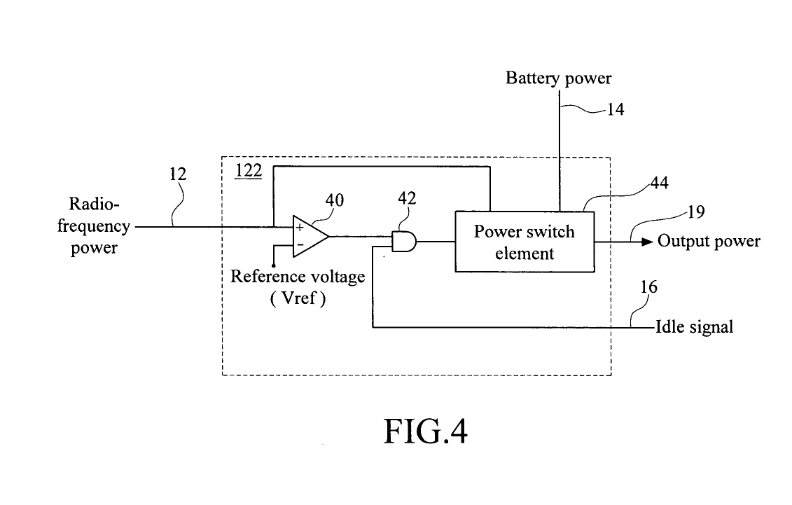

The drawings of the power management circuit 122 according to another embodiment of the present invention may be referred to FIG. 4. The power management circuit 122 includes a comparison circuit 40, a logic element 42, and a power switch element 44. The comparison circuit 40 may be a comparer, which receives a reference voltage (Vref) and a radio-frequency power 12. The comparison circuit 40 outputs a comparison signal at a high level to the logic element 42 when determining that the radio-frequency power 12 is greater than the reference voltage (Vref). The comparison circuit 40 outputs a comparison signal at a low level to the logic element 42 when determining that the radio-frequency power 12 is smaller than the reference voltage (Vref). The reference voltage (Vref) may be the abovementioned preset value, for example, but not limited to, 2.7 volts or 3.0 volts. The comparison circuit 40 may be a comparer.

The logic element 42 may be an AND gate in this embodiment. The logic element 42 receives the idle signal 16 from the micro-controller 124 and the level signal from the comparison circuit 40. When the radio-frequency mouse 100 is in the idle state, the micro-controller 124 outputs the idle signal 16 at a low level, and when the radio-frequency mouse 100 is in the busy state, the micro-controller 124 outputs the idle signal 16 at a high level. Therefore, when the radio-frequency mouse 100 is in the idle state and the comparison circuit determines that the radio-frequency power 12 is greater than the reference voltage (Vref), the logic element 42 outputs the logic signal at a high level to the power switch element 44. On the contrary, when the radio-frequency mouse 100 is not in the idle state or the comparison circuit determines that the radio-frequency power 12 is smaller than the reference voltage (Vref), the logic element 42 outputs the logic signal at a low level to the power switch element 44.

The level signal and the logic element in the embodiment of the logic element 42 are only examples, and those skilled in the art can make equivalent changes, for example, the change of the logic element into the NAND gate, or changes of levels of the logic signal and the comparison signal.

The power switch element 44 may, be but not limited to, the power switch integrated circuit (Power Switch IC) or the power switch module formed of transistors. The power switch element 44 selectively outputs the battery power 14 or the radio-frequency power 12 as the output power 19. When the signal from the logic element 42 received by the power switch element 44 is at a high level, the radio-frequency power 12 is output as the output power 19. When the signal from the logic element 42 received by the power switch element 44 is at a low level, the battery power 14 is output as the output power 19.

The battery 120 may be a non-rechargeable battery or also a rechargeable battery. When the battery is a rechargeable battery, the power management circuit 122 may further include a charging circuit (not shown). The power management circuit 122 selectively charges the battery 120 with the radio-frequency power 12 through the charging circuit according to the radio-frequency power 12. The power management circuit 122 supplies the radio-frequency power 12 to the sensor 126 and the micro-controller 124, and additionally, charges the battery 120 with the radio-frequency power 12 when the radio-frequency power 12 is greater than the preset value, so as to make full use of the radio-frequency power 12.

The sensor 126 may also be a sensor element additionally added on the radio-frequency mouse 100, for example, but not limited to, a photointerrupter disposed on a top surface of the radio-frequency mouse 100. When the user puts a hand on the radio-frequency mouse 100, the hand shields the light rays received by the photointerrupter, so the photointerrupter outputs the operation signal indicating the busy state, and when the hand of the user moves away from the radio-frequency mouse 100, the light rays are irradiated on the photointerrupter, so the photointerrupter outputs the operation signal indicating the idle state.

Furthermore, although the sensor 126 is only illustrated by a sensing element in FIG. 3, the present invention is not limited thereto. That is to say, the micro-controller 124 may receive from multiple sensor elements (for example, a left button, a right button, and a displacement sensor element) and decide whether to output the idle signal 16 or not after comprehensive judgment.

What is claimed is:

1. A radio-frequency mouse, used for receiving an electromagnetic wave transmitted by an electronic device, comprising:
a radio-frequency transceiver module, used for receiving and converting the electromagnetic wave into a radio-frequency power;
a sensor, used for outputting an operation signal according to an operating condition of the radio-frequency mouse;
a micro-controller, used for transferring the operation signal to the radio-frequency transceiver module, wherein the radio-frequency transceiver module transmits the transferred operation signal to the electronic device;
a battery, used for providing a battery power; and
a power management circuit, used for receiving the radio-frequency power, and selectively supplying the radio-frequency power or the battery power to the sensor and the micro-controller according to the radio-frequency power.

2. The radio-frequency mouse according to claim 1, wherein the power management circuit supplies the battery power to the sensor and the micro-controller when the radio-frequency power is lower than a preset value, and supplies the radio-frequency power to the sensor and the micro-controller when the radio-frequency power is higher than the preset value.

3. The radio-frequency mouse according to claim 1, wherein the micro-controller transmits an idle signal when the operation signal is an idle state, and the power management circuit supplies the radio-frequency power to the sensor and the micro-controller when the radio-frequency power is higher than a preset value and the idle signal is received, and supplies the battery power to the sensor and the micro-controller when the radio-frequency power is lower than the preset value or the idle signal is not received.

4. The radio-frequency mouse according to claim 3, wherein the power management circuit comprises:
a comparison circuit, used for comparing the preset value and the radio-frequency power and outputting a comparison signal;
a logic element, used for outputting a logic signal when the comparison signal is at a high level and the idle signal is at the high level; and
a power switch element, used for receiving the radio-frequency power and the battery power and controlling to supply the radio-frequency power to the sensor and the micro-controller when the logic signal is at the high level.

5. The radio-frequency mouse according to claim 1, wherein the radio-frequency transceiver module comprises:
an antenna, used for receiving and converting the electromagnetic wave into an alternating current;
a resonance circuit, used for receiving the alternating current and outputting a resonance voltage; and
a rectifier circuit, used for receiving the resonance voltage and converting the resonance voltage into the radio-frequency power.

6. The radio-frequency mouse according to claim 5, wherein the radio-frequency transceiver module further comprises a boost up circuit electrically connected between the resonance circuit and the rectifier circuit and used for boosting the resonance voltage and then outputting the boosted resonance voltage to the rectifier circuit.

7. The radio-frequency mouse according to claim 1, wherein the sensor is a displacement sensor, used for generating an operation signal according to a displacement of the radio-frequency mouse.

8. The radio-frequency mouse according to claim 1, wherein the power management circuit further comprises a charging circuit, and selectively charges the battery with the radio-frequency power through the charging circuit according to the radio-frequency power.

9. A radio-frequency mouse, used for receiving an electromagnetic wave transmitted by an electronic device, comprising:
a radio-frequency transceiver module, used for receiving and converting an electromagnetic wave into a radio-frequency power;
a sensor, used for outputting an operation signal according to an operating condition of the radio-frequency mouse;
a micro-controller, used for transferring the operation signal to the radio-frequency transceiver module, wherein the radio-frequency transceiver module transmits the transferred operation signal to the electronic device;
a rechargeable battery, used for providing a battery power; and
a power management circuit, used for receiving the radio-frequency power, and selectively supplying the radio-frequency power to the sensor and the micro-controller and charging the rechargeable battery or supplying power to the sensor and the micro-controller with the rechargeable battery directly according to the radio-frequency power.

10. The radio-frequency mouse according to claim 9, wherein the micro-controller transmits an idle signal when the operation signal is an idle state, and the power management circuit comprises:
a comparison circuit, used for comparing a preset value and the radio-frequency power and outputting a comparison signal;
a logic element, used for outputting a logic signal when the comparison signal is at a high level and the idle signal is at the high level;
a charging circuit; and
a power switch element, used for receiving the radio-frequency power and the battery power, and controlling to supply the radio-frequency power to the sensor and the micro-controller when the logic signal is at the high level and charge the rechargeable battery through the charging circuit, and if the logic signal is at a low level, controlling to supply the battery power to the sensor and the micro-controller.
